(19) United States
(12) Patent Application Publication
(10) Pub. No.: US 2009/0059558 A1
(43) Pub. Date: Mar. 5, 2009

(54) Flame-type illumination device having phosphor-impregnated light transmitting element for transmission of non-flickering light

(76) Inventor: Denver Smith, Delray Beach, FL (US)

Correspondence Address: MARK D. BOWEN, ESQ.;MALIN HALEY DIMAGGIO BOWEN & LHOTA, P.A., 1936 S. ANDREWS AVENUE, FT. LAUDERDALE, FL, 33316, US

(21) Appl. No.: 11/895,792

(22) Filed: Aug. 27, 2007

(51) Int. Cl. F21V 9/16

(52) U.S. Cl. 362/84

(57) ABSTRACT

A flame-based illumination device incorporates a transparent or translucent housing impregnated with phosphor to produce generally constant light emission by substantially reducing and/or eliminating the flickering effect normally associated with a flame. A housing having a phosphor impregnated transparent or translucent portion is adapted to receive a candle or other flame sustaining wick therein. The phosphor impregnated housing wall converts the flickering light generated by the flame into a sustained illuminating glow thereby effectively eliminating the inconsistent light level created by a flickering flame. In an alternate embodiment, the housing wall comprises a composite multi-layer structure including inner and outer layers with a fluid disposed therebetween. Including an intermediate water layer sandwiched between phosphor impregnated translucent layers functions, to rectify and/or magnify light emanating from the device.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to illumination devices, and more particularly to a flame-type illumination device having a shade or wind screen impregnated with phosphor to provide steady glow illumination by removing the flickering normally associated with a flame.

2. Description of Related Art

Lighting and illumination devices are available in a variety of shapes, sizes, and configurations. The use of non-electric lighting, such as by candle or lantern, to provide illumination is well known. Non-electric illumination devices often rely on flame to generate light during power outages, particularly during prolonged weather related loss of power. One problem with the use of candles and lanterns to provide light involves the erratic light patterns generated by a flickering flame. As a result, there exists a need for an improved, flame-based illumination device adapted for providing emergency lighting.

There have been a number of advancements in illumination and lighting some of which include the use of phosphorescence or glow-in-the-dark technology. For example, U.S. Pat. No. 2,000,985, issued to Quinlan et al., discloses a light modifying device for use with decorative lamps, or illuminating devices, wherein calcium sulphide is disclosed as a substance that when exposed to light is energized and will continue to glow or emit a radiance some time after the light has been turned off or removed. The substance is incorporated into a lamp shade for the purpose of modifying and altering the character of the light. U.S. Pat. No. 5,654,552, issued to Toombs, discloses a lamp shade or similar article including a glow-in-the-dark region. U.S. Pat. No. 5,692,825, issued to Shalvi, discloses a torch (e.g. flashlight) having re-chargeable batteries adapted with an electro luminescent sheet mounted behind an aperture in the body so as to produce a glow when the torch is plugged in to a live main. U.S. Pat. No. 5,833,349, issued to Apple, discloses a phosphorescent lamp shade that glows after the bulb is extinguished. U.S. Pat. No. 6,280,053, issued to Chien, discloses an electro-luminescent lighting arrangement that combines a non-electrically powered lighting device (e.g. lantern) with electro-luminescent elements. U.S. Pat. No. 7,038,399, issued to Lys et al., discloses methods and apparatus for providing power to lighting devices including LED's coated with phosphor. U.S. Pat. No. 7,132,785, issued to Ducharme, discloses an illumination system comprising LED's and a carrier material that contains phosphor to convert electromagnetism to visible light.

While the references of the background art discussed above are generally suited for achieving the limited results to which they are directed, there remains a need for an improved flame-based illumination device capable of eliminating the flickering effect of a flame to provide the user with constant glow illumination.

### BRIEF SUMMARY OF THE INVENTION

The present invention overcomes the limitations and disadvantages present in the art by providing a flame-based illumination device that incorporates a transparent or translucent housing impregnated with phosphor to produce generally constant light emission by substantially reducing and/or eliminating the flickering effect normally associated with a flame. In accordance with the present invention, an illumination device is adapted to receive a candle or other flame sustaining wick within a housing having a transparent of translucent outer wall. The housing wall functions as a flicker-eliminating lens and is preferably impregnated with phosphor, a material that exhibits the phenomenon of phosphorescence, namely a sustained glowing upon exposure to light. The light emitted by the flame acts to excite phosphor impregnated within the housing wall. The phosphor impregnated housing wall thus converts the flickering light generated by the flame into constant glow illumination thereby effectively eliminating the inconsistent light level created by a flickering flame. In an alternate embodiment, the housing wall comprises a composite multi-layer structure including a first or inner phosphor impregnated layer and an outer non-impregnated layer with a layer of water disposed therebetween. Including an intermediate water layer sandwiched between impregnated and non-impregnated glass layers functions, depending on the structure, to rectify and/or magnify light emanating from the candle.

Accordingly, it is an object of the present invention to provide an improved illumination device for use during power outages.

Another object of the present invention is to provide such a device that substantially eliminates flickering light generated by a flame.

Still another object of the present invention is to provide such a device wherein flame-generated flickering light is transformed into constant glow illumination using a phosphor impregnated lens.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of a flame illumination device having a phosphor impregnated wind screen in accordance with the present invention;

FIG. 2 is a partial side sectional view thereof; and

FIG. 3 is a side sectional view of an alternate, fluid-encased double wall embodiment.

### DETAILED DESCRIPTION OF THE INVENTION

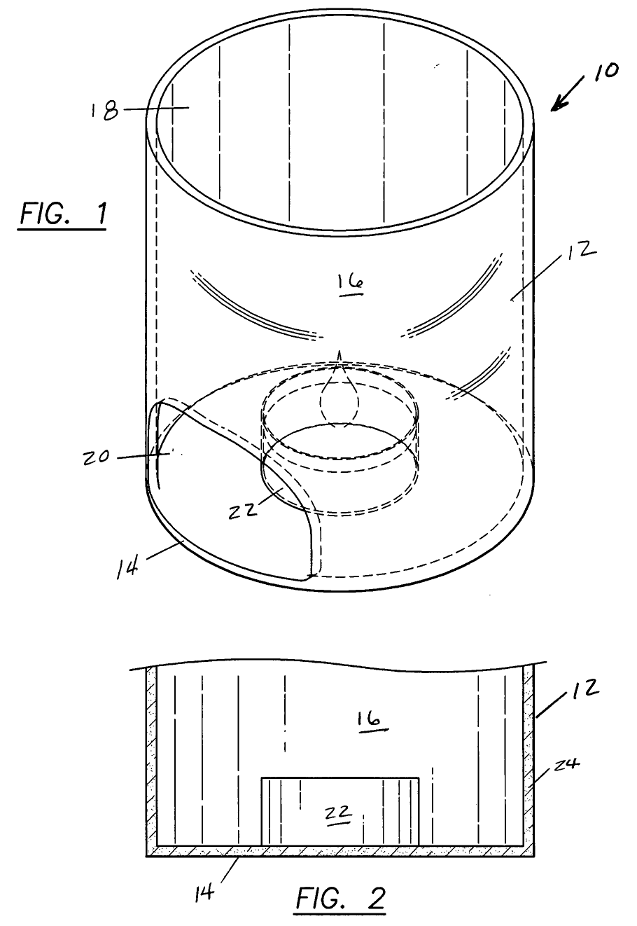

With reference now to the drawings, FIGS. 1-3 depict preferred and alternate embodiments of a flame-based illumination device, generally referenced as 10, in accordance with the present invention. An apparatus in accordance with the present invention provides an advancement in the art of flame based illumination by providing a generally constant level of light by transmitting the light through a phosphor impregnated light transmission element that eliminates the flickering normally associated with a flame.

Flame-based illumination device 10 includes a housing 12 comprises a generally cylindrical structure having a base 14 and a side wall 16. Housing 12 further includes an open top 18, and side wall 16 includes an opening 20 for providing access to a flame sustaining wick element 22 contained within housing 12. Flame sustaining wick element 22 includes a wick and associated fuel source, such as wax, oil, or other suitable fuel source. Side wall opening 20 allows for lighting and/or removal and replacement of wick element 22.

Housing 12 is preferably fabricated from transparent or translucent material impregnated with phosphor, referenced as 16. In a preferred embodiment, the entire housing 12 is fabricated from phosphor impregnated material such that the entire housing functions as a light transmitting element. In an alternate embodiment, however, housing 12 may be fabricated in part with a light transmitting element and in part with a non-light transmitting portion. FIG. 2 depicts impregnated phosphor 24 as stippling within the wall of housing 12. In a preferred embodiment, housing 12 is formed of glass fabricated by a suitable phosphor impregnating process whereby the glass contains a sufficient amount of phosphor to function in accordance with the desired functional aspects disclosed herein. The specific phosphor used is selected from a group known to emit a white illuminating glow. As noted above, the present invention contemplates the entire housing, or merely portions thereof, formed of phosphor impregnated transparent or translucent material to produce generally constant light emission by substantially reducing and/or eliminating the flickering effect normally associated with a flame.

A phosphor is a substance that exhibits the phenomenon of phosphorescence, namely a sustained glowing after exposure to light or energized particles such as electrons. Phosphors are transition metal compounds or rare earth compounds of various types. The most common uses of phosphors are in CRT displays and fluorescent lights. Phosphors are usually made from a suitable host material, to which an activator is added. The best known type is a copper-activated zinc sulfide and the silver-activated zinc sulfide (zinc sulfide silver). The host materials are typically oxides, sulfides, selenides, halides or silicates of zinc, cadmium, manganese, aluminum, silicon, or various rare earth metals. The activators prolong the emission time (afterglow). Any suitable phosphor may be adapted for use in accordance with the present invention. In accordance the a preferred embodiment, the present invention incorporates the use of a phosphor characterized by a white colored glow.

Housing 12 is preferably fabricated from glass impregnated with phosphor, however, any suitable transparent or translucent material capable of phosphor impregnation is considered within the scope of the present invention. By providing a flame source contained within a phosphor impregnated housing through which the light generated by the flame excites the phosphor so as to cause an illuminating glow to be transmitted to the surrounding environment, the housing functions as a light transmitting filter that removes the flickering normally associated with a flame so as to transmit a constant illuminating glow. By impregnating the housing wall (or portions thereof) with a suitable amount of phosphor, the housing functions as a flicker-eliminating filter or lens that via the phenomenon of phosphorescence, namely a sustained glowing upon exposure to light. Accordingly, a significant aspect of the present invention involves non-electric excitation of phosphor material to generate generally constant glow illumination, particularly for use in emergency lighting applications.

The depiction of housing 12 as being generally cylindrical is not intended to limit the structure of the present invention. Indeed, a phosphor impregnated housing may be adapted for use in a wide variety of shapes and applications. For example, housing 12 may be contoured and used to form the wind screen of a lantern. Further, housing wall 16 may be formed with convex and/or concave portions to function as a lens by refracting and focusing light from flame element 22. In addition, a mirror and/or mirrored surface may be incorporated to housing 12 to redirect light output.

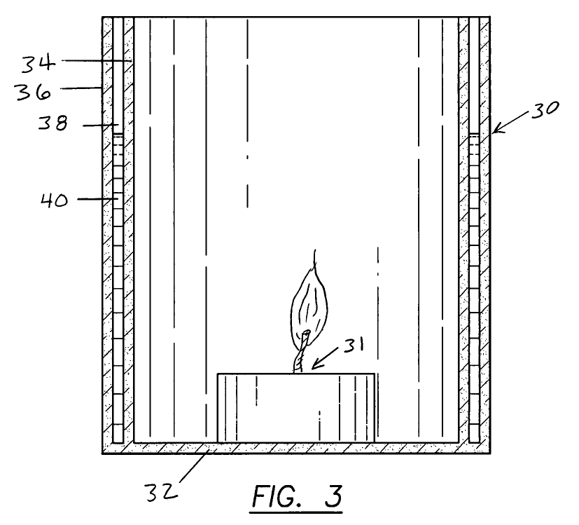

FIG. 3 depicts an alternate embodiment, double wall housing, generally referenced as 30 adapted to contain a flame element 31. Double wall housing 30, includes a base 32, an inner side wall 34 and an outer side wall 36. One or both of the inner and outer side walls, 34 and 36, comprises a transparent or translucent material impregnated with phosphor as disclosed herein above. In addition, inner and outer side walls 34 and 36 are disposed in radially spaced relation thereby forming a gap 38 into which a fluid 40, such as water, may be disposed to further filter light from flame element 31. Thus in one alternate embodiment, housing 30 may comprise a multi-layer structure including an inner phosphor impregnated layer 34 and an outer non-impregnated layer 36 with a layer of water 40 disposed therebetween. Including an intermediate water layer sandwiched between impregnated and non-impregnated glass layers functions, depending on the structure, to rectify and/or magnify light emanating from the candle.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A flame-type illumination device for illuminating a space, said device comprising:
a housing having a base and a side wall;
at least a portion of said side wall being formed of a phosphor-impregnated translucent material;
a flame sustaining wick element contained within said housing and positioned such that light light generated thereby excites the phosphor contained in said phosphor impregnated translucent material thereby causing said material to glow;
whereby said phosphor impregnated translucent material generates a generally sustained illuminating glow upon exposure to light generated by said flame sustaining wick element.

2. A device according to claim 1, wherein said side wall is generally cylindrical.

3. A device according to claim 1, wherein said translucent material is glass.

4. A flame-type illumination device for illuminating a space, said device comprising:
a housing having a base and an inner side wall and an outer side wall radially spaced from said inner side wall;
at least a portion of one of said side walls being formed of a phosphor-impregnated translucent material;
a fluid disposed between said inner and outer side walls;
a flame sustaining wick element contained within said housing and positioned for light generated thereby to pass through said translucent material;
whereby said phosphor impregnated translucent material generates a generally sustained illuminating glow upon exposure to light generated by said flame sustaining wick element

5. A device according to claim 4, wherein said side wall is generally cylindrical.

6. A device according to claim 4, wherein said translucent material is glass.
